(19) United States
(12) Patent Application Publication
(10) Pub. No.: US 2008/0163372 A1
(43) Pub. Date: Jul. 3, 2008

(54) Anti-virus system for IMS network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/715,730

(22) Filed: Mar. 8, 2007

(30) Foreign Application Priority Data
Dec. 28, 2006 (CN) 200610171293.5

(51) Int. Cl. G06F 12/14

(52) U.S. Cl. 726/24

(57) ABSTRACT

In an anti-virus system for an IMS network, anti-virus software for a wireless unit or other terminal is automatically obtained based on configuration data associated with the terminal, e.g., the terminal transmits configuration data to the anti-virus system, which uses it to select anti-virus software compatible with the terminal. Subsequently, data addressed to the terminal is scanned for viruses according to the anti-virus software. The anti-virus software may be obtained over the network for installation and use on the terminal, for either (i) on-demand or on-access virus scanning of data received by the terminal, or (ii) on-line, on-demand virus scanning. Alternatively, the anti-virus software may be obtained and implemented at the system level. Prior to incoming data being transmitted to the terminal, the system obtains anti-virus software based on the terminal's configuration, and uses the software as a basis for scanning the incoming data.

This application is entitled to the benefit of and claims foreign priority under 35 U.S.C. § 119 from Chinese Patent Application No. 200610171293.5, filed Dec. 28, 2006, the disclosure of which is hereby incorporated by reference.

### FIELD OF THE INVENTION

The present invention relates to communications and, more particularly, to user services in an IMS-based network or other communication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

An IMS-based network 10 is shown in simplified form in FIG. 1. The IMS control architecture includes a home subscriber server (“HSS”) 12 and a call session control function (“CSCF”) 14, and may generally be divided into a services/application layer 16a, an IMS layer 16b, and a transport layer 16c. The HSS 12 is the central repository of all subscriber-specific authorizations and service profiles and preferences. The HSS 12 integrates several functions/elements, some of which may exist already (for example, in the home location register of wireless networks), including subscriber/user profile database, subscriber service permissions, authentication and authorization, subscriber preference settings, mobile authentication server, and the like. An SLF 18 (subscriber location function) is needed when multiple HSS's are used. The CSCF 14 carries out the primary SIP signaling functions in the network. The CSCF 14 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 20 host and execute services, and interface with the CSCF 14 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 22 interfaces the IMS 10 with circuit-switched networks 24 such as a public switched telephone network (“PSTN”). The gateway 22 may include a BGCF (breakout gateway control function), which is an SIP server that includes routing functionality based on telephone numbers, an SGW (signaling gateway) that interfaces with the signaling plane of the network 24, an MGCF (media gateway controller function) for call control protocol conversion, and an MGW (media gateway) that interfaces with the media plane of the circuit-switched network 24. An MRF 26 (media resource function) may be provided as a media source in the network, e.g., for multimedia conferencing, text-to-speech conversation and speech recognition, and real-time transcoding of multimedia data, e.g., conversion between different codecs.

At the transport layer 16c, the IMS layer 16b is connected to a core broadband IP network 28, possibly through the MRF 26 and/or an IMS gateway 30. The IMS gateway 30 may include an IMS application layer gateway 32 (“IMS-ALG”) and a translation gateway 34 (“TrGW”) for facilitating communications with networks using different versions of the Internet protocol, e.g., IPv4 and IPv6. The core IP network 28 is also connected to one or more external IP packet data networks 36 (“IP PDN”), e.g., the Internet, and to other networks such as a DSL or other wire-line network 38, wireless local area networks (“WLAN”) 40, and wireless networks 42. Typically, one or more intermediate network elements are used for facilitating these connections, such as a WLAN access gateway (“WAG”) and/or WLAN packet data gateway (“PDG”) 44, a serving GPRS support node (“SGSN”) 46 and gateway GPRS service node (“GGSN”) 48, and a digital subscriber line access multiplexer (“DSLAM”) and broadband access server (“BAS”) 50. The SGSN 46 is responsible for mobility management and IP packet session management. It routes user packet traffic from the radio network 42 to the appropriate GGSN 48, providing access to external packet data networks, in this case the core network 28. The DSLAM 50 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 50 connects the DSL network 38 with the core IP network 28.

The networks 38, 40, 42 may be functionally/logically connected to the CSCF 14 through various control/functional elements. For example, the IMS system may include a policy decision function (“PDF”) 52, which enables the access network to be managed using dynamic policies. Additional functional elements 54 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

In an IMS-based network, as is generally the case with other communication networks, user terminals 56a, 56b provide a means for users to communicate with one another over the network(s). Each terminal is an electronic device with hardware and/or software-based functionality for communicating over a network, and typically including user input/output means such as a keyboard and display. Examples include computers and wireless units such as mobile phones and wireless PDA's (personal digital assistants, such as a Blackberry® PDA). When one terminal 56a initiates communication with another terminal 56b, the network automatically carries out various signaling procedures according to its communication protocols, in an attempt to open a communication channel between the two terminals.

With recent and ongoing advances in electronics technology, IMS and other telecommunication networks have experienced a marked increase in data transfer and processing capability. This is also the case for the data processing capability of telephone platforms and other terminals, which have become more general purpose in nature (e.g., more like computers and less like dedicated communication platforms). Along with such increases in system and terminal capacity, there has been a rapid growth in the number and types of software applications available for use on mobile phones and other terminals, such as short message applications, electronic phone directories, games, and the like. It is expected that this market segment will undergo massive growth in the near future as new telecommunication standards (e.g., SIP, GPRS, UMTS, CDMA, WAP, and HSDPA) enable the high-speed transfer of media content and other data across telecommunication networks.

As is the case with personal computers and workstations, it can also be expected that multi-purpose communication platforms/terminals will be susceptible to attack from electronic “malware.” Malware is a general term meaning any type of malicious and unwanted software designed to infiltrate or damage a computer or other processor-based device without the owner's informed consent, e.g., computer viruses, Trojan horses, worms, spyware, and adware. (Computer viruses, worms, Trojan horses, and other malware are collectively referred to hereinafter under the more colloquial term “virus” or “viruses.”) In fact, a number of mobile telephone viruses have already been identified.

To resist the attack of electronic viruses, anti-virus software is deployed on mobile phones and other wireless units in much the same way that it has been deployed in the desktop environment. The majority of anti-virus software relies on a basic scanning engine, which searches suspect files for the presence of predetermined virus signatures. These signatures are held in a database called a “virus definition library.” To reflect the most recently identified viruses, users download updates to the virus definition library from time to time, and are also expected to update the virus scanning software to take advantage of new virus detection techniques. In particular, users typically download the virus definition library and scanning software from the Internet (or obtain them from a CD-ROM or floppy disc), and then transfer the software to the wireless unit via a USB cable or the like. Because this process is time consuming, users (especially casual users such as teens or young children) may be disinclined to obtain anti-virus software. Additionally, considering that the scanning software and virus libraries are platform- or device-specific, because of the large numbers of wireless units and other terminals currently in use, it is difficult for users to know which anti-virus software to download.

### SUMMARY OF THE INVENTION

Accordingly, the present invention relates to an anti-virus system for an IMS network or other communication network. In operation, anti-virus software for a network-connected terminal is obtained based on configuration data associated with the terminal. (By “terminal,” it is meant an electronic device capable of communicating with other devices over the network 10, which may include, for example, computers, “WiFi”-equipped computers, and wireless units such as mobile phones, wireless PDA's, wireless devices with high-speed data transfer capabilities, such as those compliant with “3-G” or “4-G” standards, and the like. Also, as noted above, “virus” collectively refers to computer viruses, worms, Trojan horses, and other malware.) For example, in one embodiment the correct type of anti-virus software is determined based on the terminal's platform type, where “platform type” refers to the core operational hardware/software configuration of a terminal, typically used as the foundation of one or more related terminal models. Subsequently, data received over the network and addressed to the terminal is scanned for viruses according to the anti-virus software. Because the anti-virus software is automatically obtained based on the terminal's configuration data (which may be automatically generated by the terminal), the system does not rely on or require user selection of the anti-virus software. Additionally, because the anti-virus software is obtained directly over the network, the process of implementing anti-virus scanning for a wireless unit or other terminal is simplified, at least from the user's perspective. This results in increased levels of anti-virus scanning in the network, which reduces the overall costs associated with the harmful effects of computer viruses.

In another embodiment, the end-user terminal obtains the anti-virus software from the anti-virus system over the network. The terminal transmits configuration data to the anti-virus system, which uses the configuration data to select anti-virus software compatible with the terminal. The system transmits the anti-virus software to the terminal for automatic installation on the terminal. The anti-virus software may be configured for “on-demand” virus scanning (e.g., user-designated data is scanned upon initiation of a user command) and/or “on-access” virus scanning (e.g., all incoming content data is automatically scanned upon receipt by the terminal).

In another embodiment, the anti-virus system automatically sends update messages to the terminal. The update messages may contain software updates of the anti-virus software previously obtained by the terminal. Alternatively, the update messages may contain a text message or other communication announcing the availability of software updates, which the user can obtain over the network.

In another embodiment, the anti-virus software is obtained at the system level for use in scanning data addressed to the terminal, prior to the data being received by the terminal. For example, the anti-virus system may cross-reference the configuration data to a database that contains different anti-virus software applications for a number of different terminal platform types. Once suitable anti-virus software is obtained, it is used to scan data addressed to the terminal, but prior to the data being transmitted for final reception by the terminal. If the scanned data contains a virus signature, either the virus is disabled, if possible, or the data is dropped or discarded. Otherwise, the data is forwarded to the terminal. Typically, only content data is scanned, by which it is meant any data other than signaling data. “Signaling data” refers to data used and/or generated by the network and/or terminal for implementing communications over the network according to the network's communication protocols. Signaling data may also be scanned if processing resources permit, but it is less likely to contain viruses.

The anti-virus software may include anti-virus scanning software and/or one or more virus definition libraries. Thus, in one embodiment the anti-virus system includes general-purpose, network-based anti-virus scanning software for scanning data addressed to terminals. Prior to data being transmitted for final reception at a terminal, the anti-virus system obtains the virus definition library appropriate for the terminal platform, which the network-based anti-virus scanning software uses as a basis for scanning incoming data addressed to the terminal. In another embodiment, both an anti-virus scanning software application and a virus definition library are transmitted to the subscribing terminal. The scanning software scans data on-access and/or on-demand for the presence of viruses defined in the virus definition library.

In another embodiment, the anti-virus system allows a user to select any one of three options for virus scanning. In the first option, a subscribing terminal obtains anti-virus software from the anti-virus system over the network (e.g., based on the configuration of the terminal), which is used for on-demand and/or on-access virus scanning of data received by the terminal. (In other words, the anti-virus software is installed on the terminal for scanning data received by the terminal.) In the second option, a compact version of the anti-virus software is obtained by the terminal, which allows for on-line, on-demand scanning either (i) by the terminal receiving an updated virus definition library “on the fly;” (ii) by the terminal scanning received data according to a virus definition library, but only on-demand for designated data (e.g., the virus scanning software does not have an on-access scan function); or (iii) by the terminal transmitting previously-received data to the anti-virus system for scanning. (In other words, after the data is received at the terminal, the user initiates an on-demand anti-virus scan, resulting in the data being transmitted to the anti-virus system for scanning). In the third option, the anti-virus system scans all data addressed to a terminal for the presence of viruses, before the data is finally transmitted to the terminal. The anti-virus software used in the scanning operation is selected based on the terminal's configuration. For example, the terminal identifier contained in the data may be cross-referenced to a subscriber database, which contains the terminal's configuration data. The configuration data is then cross-referenced to a software database for obtaining anti-virus software for the terminal in question.

### BRIEF DESCRIPTION OF THE DRAWINGS

The present invention will be better understood from reading the following description of non-limiting embodiments, with reference to the attached drawings, wherein below:

FIG. 1 is a schematic view of an IMS (IP Multimedia Subsystem) network;

FIG. 2A is a schematic view of an anti-virus system for an IMS or other network according to an embodiment of the present invention;

FIG. 2B is a schematic view of an anti-virus data server portion of the anti-virus system;

FIG. 3A, 4, and 5 are signaling diagrams showing operation of various embodiments of the anti-virus system; and

FIG. 3B is a flow chart showing anti-virus software in operation on a terminal, according to an alternative embodiment of the present invention.

### DETAILED DESCRIPTION

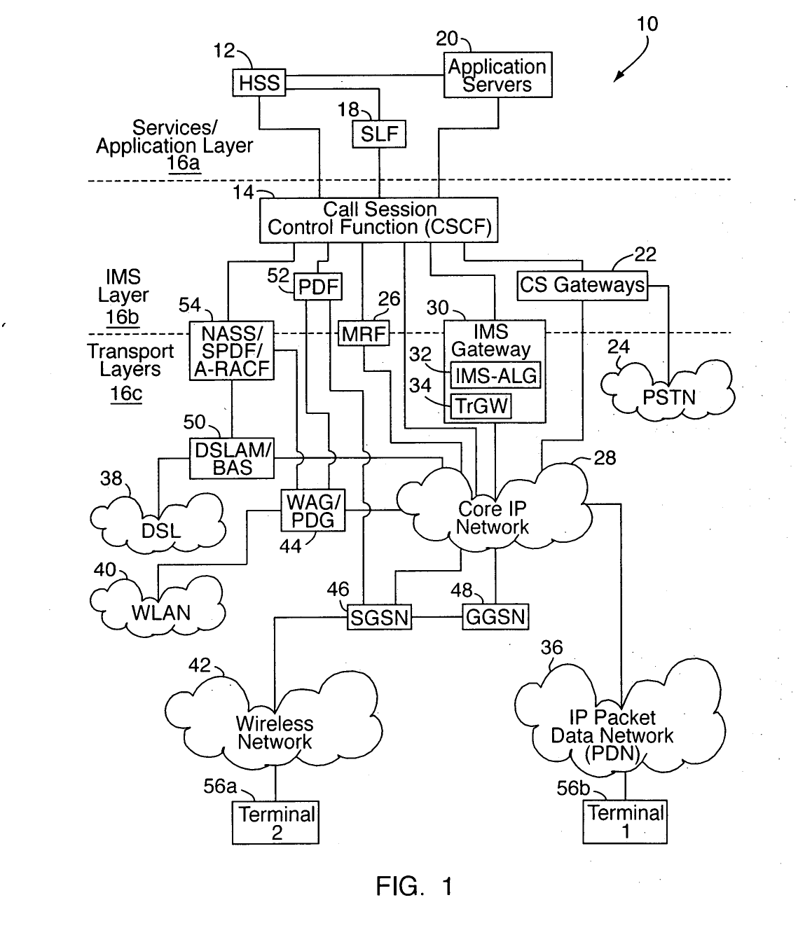

With reference to FIGS. 1-5, an anti-virus system and service 60 is implemented on or in conjunction with an IMS (IP Multimedia Subsystem) or other communication network 10. In operation, anti-virus software 62 for a network-connected end-user/subscriber terminal 64 is obtained based on configuration data 66 associated with the terminal 64. For example, in one embodiment the system 60 automatically selects anti-virus software 62 compatible with the terminal's platform type 68, as indicated in the configuration data 66 received from the terminal 64. Subsequently, data 70 received over the network 10 for transmission to the terminal 64 is scanned for viruses according to the anti-virus software 62. The anti-virus system 60 may be configured in one or more of several different manners, and possibly based on user selection on a terminal-by-terminal basis. In a first option, anti-virus software 62 is obtained from the system 60 at the terminal level for on-demand and/or on-access virus scanning of data 70 received by the terminal, e.g., the terminal first receives the data 70 and then uses the anti-virus software 62 to scan the data for the presence of viruses. In a second option, the terminal obtains a “compact” version 72 of the anti-virus software, which is configured for on-line, on-demand virus scanning, as described further below. In a third option, scanning operations are carried out at the network level. Here, upon the IMS network 10 receiving data 70 addressed to the terminal 64, and prior to transmitting the data 70 to the terminal 64, the anti-virus system 60 obtains anti-virus software 62 for scanning the data, based on configuration data 66 associated with the terminal. The data 70 is then scanned for viruses according to the software 62.

Because the anti-virus software is automatically obtained based on the terminal's configuration data (which is itself typically automatically generated by the terminal), the system is not dependent on user knowledge of anti-virus software or selection thereof. Additionally, because the anti-virus software is obtained directly over the network, the process of implementing anti-virus scanning for a wireless unit or other terminal is greatly streamlined. This makes it more likely that anti-virus scanning operations will be carried out at or on behalf of a larger percentage of user terminals, as opposed to relying on user initiative. This reduces incidents of successful virus infection, thereby reducing the costs associated therewith, e.g., data loss, identity theft, and system repair.

As discussed above, the term “virus” as used herein refers collectively to computer viruses, worms, Trojan horses, adware, spyware, and other malware.

The anti-virus system 60 may be implemented on or in conjunction with an IMS network 10. The IMS network 10 is a communication network having (or working in conjunction with) an IP Multimedia Subsystem, e.g., as generally illustrated in FIG. 1. The IMS network 10 includes an IMS portion and a number of IP (Internet protocol)-based and other networks functionally interconnected by the IMS. The IMS-interconnected networks may include the Internet 36, PSTN's 24 and other wire-line networks, and wireless networks 40, 42 such as those using CDMA, GSM, IEEE 802.11x, and/or UMTS communications or the like. The system 60 may also be implemented on other types of communication networks. Although only one terminal 64 is shown in the drawings, it will typically be the case that the system 60 accommodates a plurality of users and terminals. Each terminal 64 is an electronic device capable of communicating with other devices over the network 10, and may include, for example, computers, “WiFi”-equipped computers, and wireless units such as mobile phones, wireless PDA's, wireless devices with high-speed data transfer capabilities, such as those compliant with “3-G” or “4-G” standards, and the like. The terminals 64 communicate over the network 10 in a standard manner, depending on the network's communication protocols and the operational characteristics of the terminals. For example, in the case of wireless units and a wireless network 42, the network 42 may include one or more fixed base stations (not shown) having various transceivers and antennae for wireless, radio-frequency (RF) communications with the wireless units over one or more RF channels, in a manner based on the wireless communication method and protocol used. Additionally, in the case of an IMS network 10, the terminals will be configured to communicate using IP-based (e.g., packet data) communications such as TCP/IP.

As noted above, the system 60 may be configured for a user to select the type of anti-virus scanning operation to be carried out by or on behalf of the user's terminal. Possible anti-virus scanning operations include terminal based on-demand or on-access anti-virus scanning, on-line, on-demand scanning carried out at the terminal in cooperation with the anti-virus system 60 (or vice versa), and network-based scanning. Alternatively, the system 60 may be configured for only one or two of these operations, or for a similar operation.

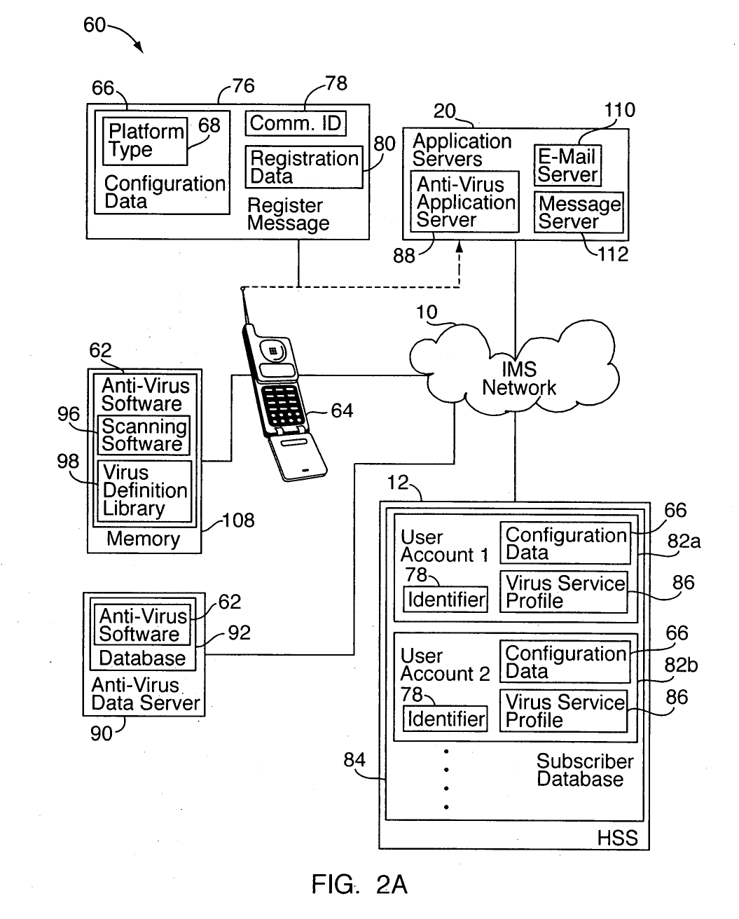

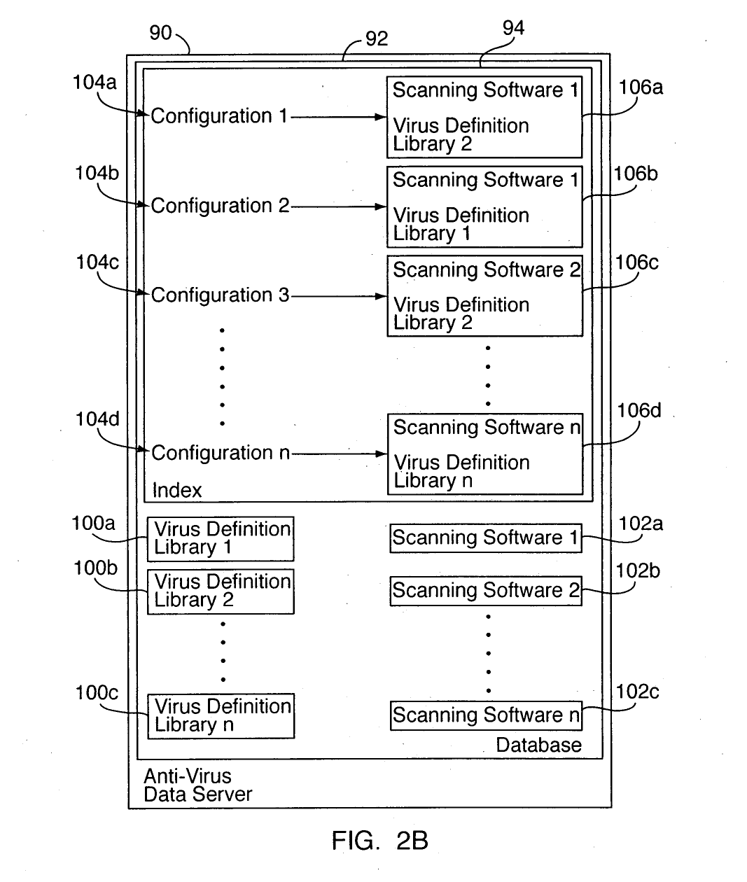

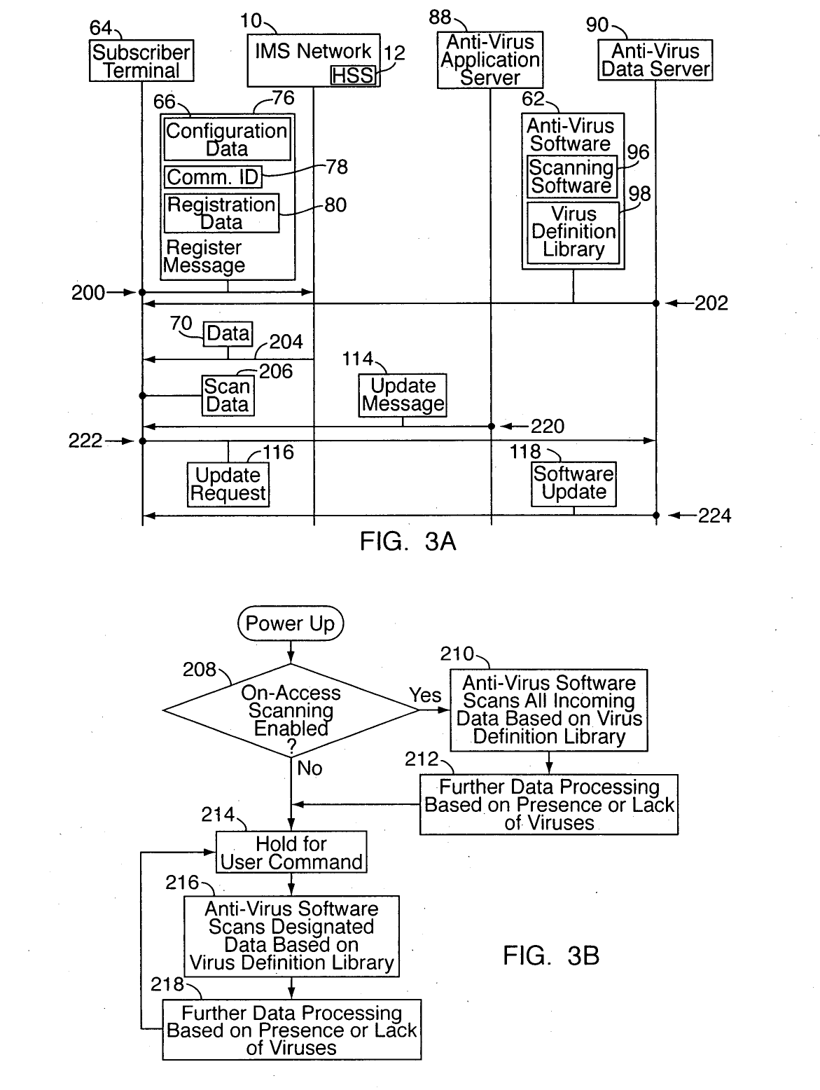

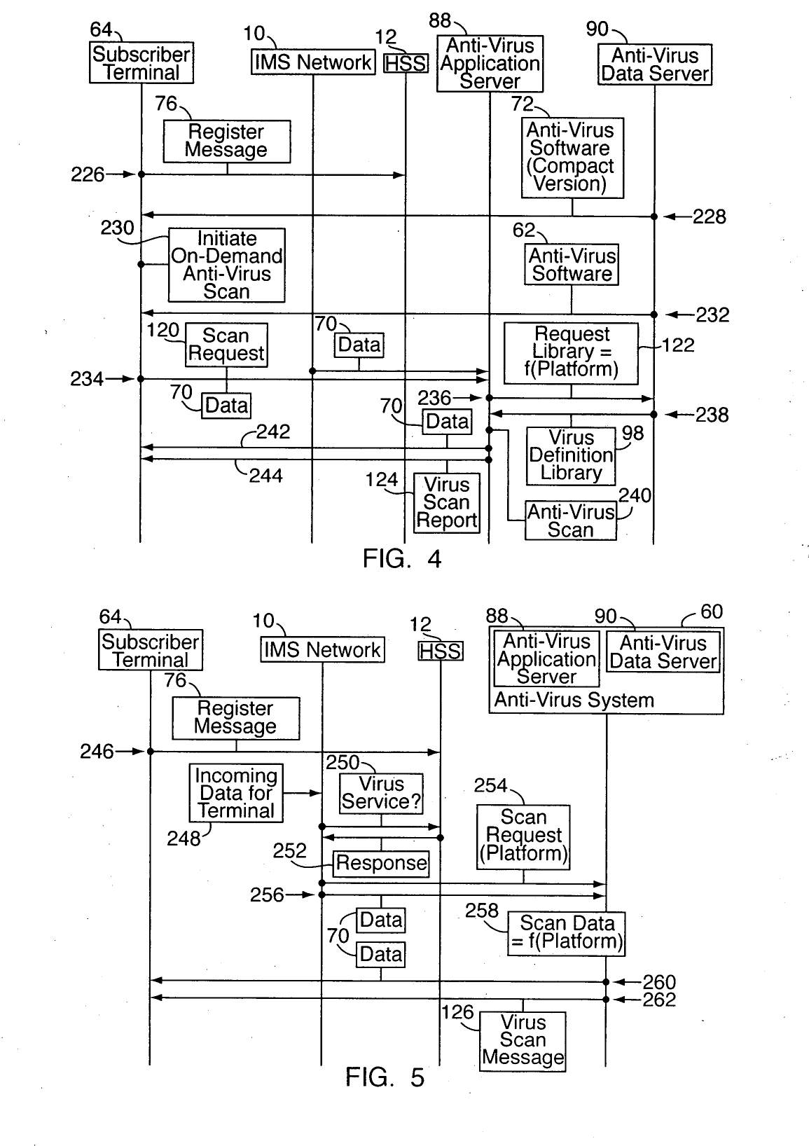

FIGS. 2A-3B illustrate a terminal-based anti-virus scanning operation according to one embodiment of the present invention. At Step 200, the terminal 64 sends a register message 76 to the HSS 12 or elsewhere in the network 10. The register message 76 contains the configuration data 66 associated with the terminal, which may include the platform type 68 of the terminal and/or other information relating to the hardware and/or software configuration of the terminal, e.g., chipset(s), operating system, and the like. The register message 76 also contains a communication identifier 78 (“Comm. ID”) associated with the user and/or terminal 64, and possibly registration data 80 for registering with the system 60. For example, the registration data 80 may relate to user preferences for the anti-virus scanning service, e.g., the type of anti-virus operation to carry out (if more than one option is provided), and options relating to how the selected operation is to be carried out (if the system allows the user to configure the selected scanning operation). For routing the register message 76 over the network 10, the register message 76 may contain a register header or other data that the HSS 12 and/or system 60 associates with register messages, and/or the register message 76 may be sent to a specially designated network address or other destination in the network to which register messages are sent for registering terminals for the anti-virus service. The register message 76 may be sent upon the user selecting to register with the anti-virus service, or automatically upon initial setup of the terminal 64 for communication over the network 10.

Upon receipt of the register message 76, the HSS 12 processes the register message 76 for registering the terminal 64 with the anti-virus service 60. For this, the HSS 12 first determines whether the terminal 64 has an established network user account 82a, 82b by cross-referencing the communication identifier 78 in the register message 76 to an HSS subscriber database 84. (The HSS subscriber database 84 contains a user account 82a, 82b for each user and/or terminal 64 authorized to communicate over the network 10. Each user account 82a, 82b includes the identifier 78 of its associated terminal 64, as well as other information (not shown) relating to the user and/or terminal, including contact information such as address and phone number, system/user preferences, billing information, and the like.) If required, the HSS 12 also determines whether the terminal 64 is authorized to sign up for the anti-virus service. For example, in the network the terminals may be divided into service classes, only some of which provide the anti-virus scanning service. Next, if financial charges are associated with using the anti-virus scanning service 60, the HSS 12 generates billing data relating to the service(s) selected by the user. This may involve: (i) modifying the user account 82a, 82b to indicate that the user has registered with the anti-virus scanning service; (ii) generating and sending billing data to a network billing server; (iii) processing payment information included in the register message 76 (or otherwise communicated between the terminal 64 and HSS 12), e.g., credit card or other billing information; or (iv) a similar operation. Finally, the HSS 12 adds a virus service profile or entry 86 to the user account 82a, or modifies an existing virus service profile/entry 86. The virus service profile 86 indicates that the user has registered for the anti-virus scanning service, and contains a listing of user preferences for the service, if any.

Upon the user registering with the HSS 12 for the anti-virus scanning service, the HSS 12 informs the system 60 of the new registration, by way of forwarding the register message 76 to the system 60. Alternatively, another message or other communication may be generated and transmitted to the system 60. If so, such a message would typically also contain the configuration data 66 (or a subset thereof) and the communication identifier 78 or other means for identifying the terminal 64. The configuration data 66 is used as a basis for selecting the anti-virus software 62, which is subsequently transmitted to the terminal 64 using the communication identifier 78.

According to one possible configuration for terminal-based virus scanning, the HSS 12 forwards the register message 76 to an anti-virus application server 88, which is configured to coordinate the central operation of the anti-virus system 60. The anti-virus application server 88 communicates with an anti-virus data server 90, which acts as a data repository for the anti-virus software 62. The data server 90 includes a database 92, which contains the software 62 and an index 94 or similar function that correlates the software 62 to terminal configuration data 66. In effect, the data server 90 provides a means for automatically selecting anti-virus software 62 compatible with different types/configurations of terminals in the network. For a terminal 64 to carry out terminal-based scanning operations, the software 62 includes an anti-virus scanning software application 96 and a virus definition library 98. The scanning software 96 is configured to scan data for the presence of viruses as defined in the virus definition library 98. Both are configured for operation on or with respect to the terminal, e.g., the scanning software 96 is configured to run on the terminal, and the virus definition library 98 contains the definitions of viruses that could possibly “infect” the terminal. For network-based anti-virus scanning operations, as discussed further below, it may be the case that general purpose scanning software is used for all data, with virus definition libraries being obtained as the terminal-specific software 62 based on terminal configuration data 66.

For selecting appropriate anti-virus software based on terminal platform or other configuration data, the anti-virus data server database 92 may be configured in any one of a number of different manners, according to standard database design principles. One example is shown in FIG. 2B. There, the database 92 includes an index 94, a plurality of virus definition libraries 100a-100c, and a plurality of anti-virus scanning software applications 102a-102c. (Although the software 100a-100c, 102a-102c is shown as being part of the database, more typically the software will simply be stored in mass storage on the data server.) The index 94 includes one or more configuration listings 104a-104d, each of which is for a different configuration (e.g., platform type) of terminal expected to communicate over the network 10. Typically, there will be a listing for each type, platform, or configuration of terminal communicating over the network 10, or at least some portion thereof, with new listings being added as new platforms are launched. Associated with each configuration listing 104a-104d is a software listing 106a-106d. The software listing 106a-106d contains a data entry of anti-virus software 62 compatible with the associated terminal configuration 104a-104d. In other words, the software applications identified in the software listings 106a-106d are configured to run on terminals having configurations as set forth in the corresponding configuration listings 104a-104d. As shown in FIG. 2B, the software listings 106a-106d may each identify one of the anti-virus scanning software applications 102a-102c and one of the virus definition libraries 100a-100c.

In operation, upon receipt of the register message 76 or a similar message from the HSS 12 or elsewhere in the network 10, the anti-virus application server 88 transmits at least the configuration data 66 to the anti-virus data server 90. Based on the configuration data 66, the data server 90 selects the anti-virus software 62 for the terminal 64 (e.g., the software is selected based on it being compatible with the terminal 64), and transmits it at Step 202 to the terminal 64. In particular, for the database configuration shown in FIG. 2B, the data server 90 queries the database 92 or otherwise cross-references the configuration data 66 to the index 94. Once the data server 90 determines which configuration listing 104a-104d matches (or most closely matches) the received configuration data 66, it accesses the software listing 106a-106d corresponding to the matching configuration listing. Subsequently, the data server 90 retrieves the software 62 listed in the corresponding software listing from the database 92, which may include a scanning application 102a-102c and a virus definition library 100a-100c. The software 62 is transmitted to the terminal 64 at Step 202.

Once the terminal 64 obtains the software 62 from the anti-virus system 60, it is stored in temporary and/or permanent memory or other data storage 108. Then, the terminal 64 automatically installs the software 62 in a standard manner. (The manner of installation may also depend on user selection of one or more options for the software, and may request the user to consent to the installation.) At Step 204, the terminal 64 receives data 70 over the network 10. For example, the data 70 could comprise a phone call, an e-mail message received from a network e-mail server 110, or a short message received from a network message server 112. If the software 62 is configured for on-access scanning (e.g., for automatically scanning all received data), at Step 206 the terminal 64 scans the data 70 upon arrival according to the software 62. For example, if the software 62 includes anti-virus scanning software 96 and a virus definition library 98, the terminal 64 initiates operation of the scanning software 96, which scans the data 70 for signatures of viruses as defined in the virus definition library 98. If the data 70 contains viruses, it is further processed according to the particular characteristics or configuration of the software 62. For example, virus infected data 70 may be discarded, flagged for the presence of viruses (e.g., in conjunction with a user option of whether to discard the data or execute or store the data), cleansed from virus contamination, or the like, in a standard manner. If the data 70 is virus-free, it is further processed by the terminal in a normal manner, which may include storage, display, and/or execution of the data. If the software 62 is configured for on-demand scanning, it scans data 70 similarly as described above. However, the scanning is carried out upon user initiation of the scanning process, and for user-designated data, possibly in conjunction with software generated prompting. For example, for on-demand use, the software 62 may be configured to prompt the user whether to carry out a scanning operation for a “suspicious” or un-trusted application or other attachment received over the network 10.

This process is summarized in FIG. 3B for software 62 configured for on-access and/or on-demand scanning at the user's option. At Step 208, after power-up of the terminal 64, the software cycles through a mode check to determine if the user has enabled on-access scanning. If so, at Step 210 the anti-virus scanning application scans all data received at the terminal for the presence of viruses as defined in the virus definition library. At Step 212, the scanned data is further processed based on whether it contains viruses. These operations are carried out on a continuing and ongoing basis as long as the on-access feature is enabled. Regardless of whether on-access scanning has been enabled, at Step 214 the terminal “holds” for user initiation of on-demand scanning. (In other words, the terminal continues to function as normal, but initiates on-demand scanning upon user selection of the on-demand function.) When the user initiates on-demand scanning via a menu option on the terminal or the like, the anti-virus scanning application prompts the user for the data to be scanned. For example, the data may be a file, attachment, application, or the like. Then, at Step 216, the scanning software scans the designated data for the presence of viruses as defined in the virus definition library. At Step 218, the designated data is further processed based on whether it is found to contain viruses.

At Step 220 in FIG. 3A, the anti-virus system automatically sends update messages 114 to the terminal 64, on a periodic basis. The update messages 114 may contain software updates of the anti-virus software 62 previously obtained by the terminal 64. Alternatively, the update messages 114 may include text messages or the like announcing the availability of software updates, which could then be obtained by the user over the network 10. In either case, the anti-virus system includes a function for tracking the types/versions of software 62 obtained by terminals subscribed to the anti-virus service, and that automatically generates and transmits the update messages when software updates become available. Information relating to the software obtained by each terminal may be appended to the user accounts 82a, 82b as part of the virus service profiles 86. When a software update becomes available, the system 60 queries the HSS subscriber database 84 to identify which terminals obtained previous versions of the newly updated software. Update messages are then generated and transmitted to the identified terminals.

Instead of server-initiated software updates, the anti-virus software 62 installed on the terminal 64 may be configured to periodically initiate communications with the anti-virus system 60 for determining whether software updates are available. For example, at Step 222 the anti-virus software 62 transmits an update request message 116 to the anti-virus application server 88 and/or anti-virus data server 90, which responds at Step 224 by transmitting to the terminal 64 an update 118 of the software 62 on the terminal, if one is available. For this function, information identifying or otherwise relating to the software 62 obtained by the terminals may be stored as part of the user accounts 82a, 82b in the HSS subscriber database 84. When the system 60 receives an update request message 116 from a terminal 64, the system 60 queries the HSS subscriber database 84 to determine which software 62 the terminal 64 most recently obtained. The system 60 then determines if an update is available for the software (e.g., by querying a database/list maintained for this purpose), and transmits the software update 118 to the terminal if one is available. Alternatively, the update request message 116 may contain information identifying the software 62 on the terminal 64.

The anti-virus system 60 may additionally be configured for on-line, on-demand virus scanning, either primarily or as an alternative to options of network-based scanning and terminal-based scanning. Here, the terminal 64 obtains a “compact” version of the anti-virus software 72 (see FIG. 4), which is a software suite including less than a full anti-virus scanning application and/or full virus definition library. Virus scanning operations are carried out either: (i) by the terminal receiving a current virus definition library “on the fly;” (ii) by the terminal scanning received data according to a virus definition library, but only on-demand and for designated data (e.g., the virus scanning software does not have an on-access scan function); or (iii) by the terminal transmitting previously received data to the anti-virus system for scanning. (In other words, after the data is received at the terminal, the user initiates an on-line, on-demand anti-virus scan, resulting in the data being transmitted to the anti-virus system for scanning). These scanning operations are illustrated in FIG. 4. At Step 226 the terminal 64 transmits a register message 76 to the HSS 12, which responds similarly to as described above with respect to FIG. 3A. At Step 228, the anti-virus data server 90 transmits a compact anti-virus software application 72 to the terminal 64, where it is automatically installed. At Step 230, according to one possible configuration, the user initiates an on-demand anti-virus scan. The software 72 informs the anti-virus system 60 that the user has initiated the on-demand scan with the anti-virus software 72, including possibly supplying the version or release number of the software 72. At Step 232, if the system 60 finds that the anti-virus software 72 is not the most up-to-date version of the anti-virus software, it selects anti-virus software 62 for the terminal (e.g., based on the terminal's platform type or other configuration), and transmits it to the terminal 64 for use in scanning data. For example, the software 62 may comprise a virus definition library (or an update thereof), which the compact software 72 uses as a basis for scanning data. As should be appreciated, this configuration ensures that the terminal has the most up-to-date virus definition library for each scanning operation, and may also obviate the need for the terminal 64 to store the virus definition library in permanent memory or other data storage.

According to a second possible configuration for on-line, on-demand scanning, the “compact” software 72 is a client-side application for coordinating transmission of data to the system 60 for scanning. At Step 234 the user initiates on-demand scanning by selecting a function for this purpose on the software 72 installed on the terminal 64. The software 72 transmits a scan request 120 to the anti-virus application server 88, along with designated data 70 previously received by the terminal 64. For example, the data 70 may be a software application or e-mail or message attachment. Alternatively, the data 70 may originate from the network 10, e.g., the network 10 informs the user that data is waiting for transmission and the user responds by requesting that the data first be scanned for viruses. At Step 236, the application server 88 obtains the anti-virus software 62 from the anti-virus data server 90. In particular, the application server 88 transmits a software request message 122 to the data server 90. The message 122 contains the configuration data 66 (or a portion thereof), which the data server 90 uses as a basis for selecting the software 62. In this example, the software 62 is a virus definition library 98. At Step 238, the data server 90 transmits the selected virus definition library 98 to the application server 88. At Step 240, the application server 88 scans the data 70 using general-purpose virus scanning software, which scans for viruses as defined in the virus definition library 98 obtained from the data server. (The scanning operation can instead be carried out at the data server, if desired.) If the data 70 is free from viruses, at Step 242 the application server 88 transmits the data 70 to the terminal 64. Alternatively, if the terminal 64 still has the data 70 stored thereon, the application server 88 may discard the scanned data 70 and transmit a virus scan report 124 to the terminal indicating that the data is virus-free, as at Step 244. If the data is found to contain one or more viruses, the data may be “disinfected,” if possible, and then transmitted back to the terminal. Otherwise, the data is dropped or deleted, with the virus scan report 124 indicating that viruses were present. If virus-infected data 70 is still stored on the terminal 64, the software 72 may be configured to delete the data upon receipt of the report 124, or to prompt the user for optional deletion of the data.

According to a third possible configuration for on-line, on-demand scanning, the “compact” software 72 includes a virus definition library and a virus scanning software application for on-demand scanning only. The scanning software is installed on the terminal as described above with respect to FIG. 3A, but is configured solely for the on-demand scanning of designated data, e.g., for the presence of viruses as defined in the virus definition library.

As should be appreciated, if the system 60 includes scanning or other software 62 installed on user terminals 64, the software 62 will be configured to generate a user interface on the terminal. The user interface allows the user to configure and/or initiate anti-virus scanning operations. For example, the user interface may display a “virus scan” menu option on the terminal, accessible as one of the menu options in the terminal's menu hierarchy. (Most wireless units include a software-based menu system, displayed on the wireless unit's display and accessible through the wireless unit's keypad, which includes options for controlling the wireless unit, accessing messages, and the like. Also, most computer terminals include a graphical user interface allowing a user to select different options for controlling the computer.) Selecting the virus scan menu option allows a user to enable or disable on-access scanning, initiate on-demand scanning, or the like. Such user interface functionality can be programmed using standard methods depending on the types of terminals involved.

Referring to FIG. 5, the anti-virus system 60 may additionally be configured for network-based, system-level scanning, either primarily or as an alternative to the options for on-line, on-demand scanning and/or terminal-based scanning. Here, the system 60 obtains anti-virus software 62 for use in scanning data 70 addressed to the terminal 64, prior to the data being transmitted to the terminal. At Step 246, the terminal 64 transmits a register message 76 to the HSS 12, which responds similarly to as described above with respect to FIG. 3A. At Step 248, the network 10 receives data addressed to the terminal 64. At Step 250, a network switch (e.g., a network entity/component in charge of routing data/communications, such as the CSCF 14) queries the HSS subscriber database 84 to determine whether the terminal 64 is subscribed to the anti-virus scanning service. This is done by cross-referencing the communication identifier in the received data 70 (e.g., the data is addressed to the communication identifier) to the database, accessing the user account 82a, 82b associated with the communication identifier, and accessing the virus service profile 86 in the user account. (If a virus service profile 86 is only generated when a user subscribes to the service, then the lack of a virus service profile in a user account indicates that the user has not subscribed to the service 60.) At Step 252, the HSS subscriber database 84 issues a response indicating whether the terminal is subscribed to the virus scanning service. If not, the data is further processed according to network communication protocols in a standard manner. If so, at Step 254 an anti-virus scan request is transmitted to the anti-virus application server 88 or anti-virus data server 90. The scan request includes the terminal configuration data 66 or the like, which may have been obtained from the HSS database as part of the response in Step 252. The scan request informs the anti-virus system (i) of the terminal's platform type or other configuration data and (ii) to expect incoming data for the terminal. At Step 256, the network 10 commences transmission of the data 70 to the anti-virus system 60. At Step 258 the anti-virus system 60 obtains anti-virus software 62 based on the terminal's platform type or other configuration data, and scans the data according to the obtained software 62. (The software is typically obtained before the data is received by the anti-virus system.)

For example, in one embodiment the scanning operations are carried out by the anti-virus data server 90. Upon receipt of the scan request message at Step 254 (which includes the configuration data 66), the anti-virus data server 90 queries the data server database 92 for determining the appropriate software to use for scanning the data 70. This may be done as described above with respect to FIG. 2B, e.g., the software is selected based on its compatibility with the terminal type, platform, or other configuration, as indicated in the configuration data. Then, the data server retrieves the identified software, which will typically include a virus definition library 98 for the particular terminal configuration. If general-purpose virus scanning software is used, then the anti-virus data server initiates operation of the general purpose scanning software, which scans the data 70 for signatures of viruses as defined in the selected virus definition library. On the other hand, if different scanning software applications are required for scanning data addressed to different terminals even at the network level, then the scanning software is also selected as part of the database query and used to scan the data 70. Data will most often be scanned in real time, as it is received, but may also be scanned only after all the data is received.

At Step 260, for all data found to be virus-free, that data is transmitted from the anti-virus system 60 to the terminal 64. If viruses are found during the scanning operation, the associated data is either dropped, or the viruses are disabled, if possible. At Step 262, the anti-virus system 60 optionally transmits a virus scan report or message 126 to the terminal, indicating whether and to what extent the data 70 contained viruses. For example, if the virus scanning software is configured to drop data upon finding a virus therein, the report 126 informs the user that the data was infected and, as such, discarded or deleted for security purposes. The virus scan report 126 may include other information, such as the virus type and virus source address.

To summarize operation of the system as shown in FIG. 5, upon the network 10 receiving data addressed to a terminal 64 which has subscribed to the anti-virus service, the anti-virus system cross-references the configuration data 66 of the terminal to a database 92 that contains different anti-virus software applications for a number of different terminal platform types. Once suitable anti-virus software is obtained, it is used to scan the data addressed to the terminal, but prior to the data being transmitted for final reception by the terminal. If the scanned data contains a virus, either the virus is disabled, if possible, or the data is dropped or discarded. Otherwise, the data is forwarded to the terminal.

The anti-virus system 60 may be configured for sole or primary operation according to any of the embodiments described above. Alternatively, the system 60 may be configured for user selection of the type of virus scanning operation to be carried out by or on behalf of the user's terminal, from among several different options. In the first option, a subscribing terminal obtains anti-virus software from the anti-virus system over the network (e.g., based on the configuration of the terminal), which is used for on-demand and/or on-access virus scanning of data received by the terminal. (In other words, the anti-virus software is installed on the terminal for scanning data received by the terminal.) In the second option, a compact version of the anti-virus software is obtained by the terminal, which allows for on-line, on-demand scanning as described above. In the third option, scanning is network-based, with the anti-virus system scanning data addressed to subscriber terminals prior to the data being finally transmitted to the terminals.

In one embodiment of the system 60, only content data is scanned, by which it is meant any data other than signaling data. “Signaling data” refers to data used and/or generated by the network and/or terminal for implementing communications over the network according to the network's communication protocols. Signaling data may also be scanned if processing resources permit, but it is less likely to contain viruses.

Although the system 60 has been shown as including an anti-virus data server and an anti-virus application server, the system may be implemented using a single server terminal that incorporates the functions of both anti-virus servers as discussed above, without departing from the spirit and scope of the invention.

As should be appreciated, the anti-virus scanning software functions in a standard manner, and may be developed for operating on or with respect to different terminal platforms using standard programming methods, as are well known in the art. Additionally, the virus definition libraries are standard modules developed using methods standard to the industry, e.g., technicians monitor reports of virus infections and/or other sources of existing or potential viruses such as “hacker” websites, obtain copies of the viruses (or other information describing the viruses), and add the virus software code to the libraries.

The anti-virus system 60, network 10, and/or terminals 64 may be augmented for informing users about the service and for providing user interface functionality for users to register with the service. For example, terminals subscribed to the network may be programmed with a built-in menu option allowing users to subscribe to the anti-virus service. Additionally, the network 10 or system 60 may be configured to issue advertisements or other informative messages to the terminals 64, which are displayed for informing users of the service's availability. Users may also register with the service via a website or the like.

Although in certain instances it is shown that both anti-virus scanning software and a virus definition library are obtained over the network, it may also be the case that the two are integrated. For example, the anti-virus scanning software could include a built-in listing or database of virus definitions.

Since certain changes may be made in the above-described anti-virus service for IMS network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of processing data in an IP multimedia subsystem (IMS) network, said method comprising the steps of:
automatically obtaining anti-virus software based on configuration data associated with a terminal; and
scanning content data addressed to the terminal for viruses according to said anti-virus software, said content data being received over the IMS network.

2. The method of claim 1 wherein the anti-virus software comprises anti-virus scanning software and a virus definition library, said anti-virus scanning software and library being configured for operation on the terminal and for detecting viruses associated with a platform type of said terminal.

3. The method of claim 2 further comprising:
transmitting a register message from the terminal over the network, said register message including the configuration data; and
installing the anti-virus software on the terminal, said anti-virus software being received by the terminal over the network.

4. The method of claim 3 further comprising:
automatically scanning all content data received at the terminal over the network according to the anti-virus software.

5. The method of claim 3 further comprising:
scanning designated content data received at the terminal based on a user command.

6. The method of claim 1 further comprising:
automatically cross-referencing the configuration data to a database for obtaining said anti-virus software, said database including a plurality of anti-virus software for a plurality of terminal platform types, wherein the configuration data is contained in a register message received from the terminal over the network.

7. The method of claim 6 further comprising:
scanning all content data addressed to the terminal according to the anti-virus software, said content data being received at a network server and being scanned prior to transmission of any of said content data to the terminal.

8. The method of claim 7 further comprising:
for all virus-free content data identified in said scanning operation, forwarding said virus-free content data to the terminal over the network; and
for all virus-infected content data identified in said scanning operation, processing said virus-infected content data according to a selected one of (i) discarding said virus-infected content data and (ii) disabling at least one virus in the virus-infected content data prior to transmission to said terminal.

9. The method of claim 6 further comprising:
transmitting the anti-virus software to the terminal over the network; and
periodically automatically transmitting an update message to the terminal, said update message including at least one of a software update of the anti-virus software and a notification relating to said software update.

10. A method of processing data in a communication network, said method comprising the steps of:
automatically obtaining anti-virus software based on configuration data associated with a wireless unit; and
scanning content data addressed to the wireless unit for viruses according to said anti-virus software, said content data being received over the network.

11. The method of claim 10 wherein the anti-virus software comprises anti-virus scanning software and a virus definition library, said anti-virus scanning software and library being configured for operation on the wireless unit and for detecting viruses associated with a platform type of said wireless unit.

12. The method of claim 10 further comprising:
transmitting a register message from the wireless unit over the network, said register message including the configuration data; and
installing the anti-virus software on the wireless unit, said anti-virus software being received by the wireless unit over the network.

13. The method of claim 10 further comprising:
cross-referencing the configuration data to a database for obtaining said anti-virus software, said database including a plurality of anti-virus software for a plurality of wireless unit platform types, wherein the configuration data is contained in a register message received from the wireless unit over the network.

14. The method of claim 13 further comprising:
scanning all content data addressed to the wireless unit according to the anti-virus software, said content data being received at a network server and being scanned prior to transmission of any of said content data to the wireless unit.

15. The method of claim 10 further comprising:
scanning all content data addressed to a wireless unit for viruses prior to transmission of any of said content data to the wireless unit, said content data being scanned according to the anti-virus software;
for virus-free content data identified in said scanning operation, forwarding said virus-free content data to the wireless unit over the network; and
for virus-infected content data identified in said scanning operation, processing said virus-infected content data according to a selected one of (i) discarding said virus-infected content data and (ii) disabling at least one virus in the virus-infected content data and forwarding the content data to the wireless unit.

16. The method of claim 15 wherein the configuration data is included in a message received from the wireless unit over the network.

17. The method of claim 16 wherein the network is an IP multimedia subsystem (IMS) network.

18. A method of data transmission in an IP multimedia subsystem (IMS) network, said method comprising the steps of:
transmitting anti-virus software to a wireless unit over the IMS network; and
periodically automatically transmitting an update message to the wireless unit, said update message including at least one of a software update of the anti-virus software and a notification relating to said software update.

19. The method of claim 18 further comprising:
selecting said anti-virus software based on configuration data associated with the wireless unit, said configuration data being included in a message received from the wireless unit.

20. The method of claim 19 further comprising:
cross-referencing the configuration data to a database for selecting said anti-virus software, said database including a plurality of anti-virus software for a plurality of wireless unit platform types.
